(19) United States
(12) Patent Application Publication
(10) Pub. No.: US 2010/0151105 A1
(43) Pub. Date: Jun. 17, 2010

(54) GRAIN POWDER COMPOSITION

(75) Inventor: Yoji KAMEO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KAO CORPORATION, Chuo-ku (JP)

(21) Appl. No.: 12/636,045

(22) Filed: Dec. 11, 2009

(30) Foreign Application Priority Data
Dec. 16, 2008 (JP) 2008-319435

(51) Int. Cl. A23L 1/0522; A23L 1/05; A21D 13/00; A23L 1/164; A23L 1/305

(52) U.S. Cl. 426/559; 426/622; 426/549; 426/560; 426/578

(57) ABSTRACT

The invention is a grain powder composition containing (A) wheat flour, (B) an gelatinized modified starch, and (C) wheat protein, wherein a mass ratio of (A)/(B) is 55/45 to 85/15, and a content of (C) is 0.5 to 4 parts by mass with respect to the total 100 parts by mass of (A) and (B).

### FIELD OF THE INVENTION

The present invention relates to a grain powder composition.

### BACKGROUND OF THE INVENTION

Baked confectionery has been conventionally required to have a light feel of food, a good dissolving feel in the mouth and no powdery feel in the mouth.

Recent consumer tastes are diversified. There is a trend in the direction of new food outside preconceived ideas, or a food having a new feel of food never experienced before. For baked confectionary, there is a growing tendency to have a moister feel than ever while keeping a good dissolving feel in the mouth and no powdery feel in the mouth.

To meet the tendency, there are proposed methods of imparting a moist feel by blending gelatinized starch and/or gelatinized modified starch.

For example, JP-A-8-38028 discloses a technique of producing baked confectionery having moist and a glutinous feel by adding gelatinized wheat flour and/or gelatinized starch, and an etherified starch to wheat flour.

It, however, is described in JP-A-8-38028 that, when an incorporated amount of gelatinized wheat flour and/or gelatinized starch is more than 30 parts by weight with respect to 100 parts by weight of starch based material, a resultant has paste-like feel in the mouth (gelatinizing feel), not having a sufficient swelling and a glutinous feel. It is also described there that, when an incorporated amount of etherified starch is more than 30 parts by weight with respect to 100 parts by weight of starch based material, a resultant has a sticky feel, not having an inadequate solidification. Baked confectionery has this way a problem that a large amount of gelatinized starch and modified starch can't be incorporated. JP-A-8-38028 does not describe conservation of feel of food in storage.

JP-A 2007-325526 discloses a technique of blending 0.2 to 10 parts by mass of gelatinized modified waxy potato starch to 100 parts by mass of starting grain powder. JP-A 2007-325526 describes that the technique produces a bakery food having soft and moist feel with small temporal degradation in quality.

However, JP-A 2007-325526 also describes that when an increased amount of gelatinized modified waxy potato starch is used, a resultant bakery food has decreased moist feel and dissolving feel in the mouth and poor appearance. The technique also has a limitation in blending amount of processed starch.

JP-A 61-187740 discloses a method of producing baked confectionary such as a sponge cake and a crepe skin with water-soluble adhesive paste and/or gluten and starch sugar such as reduced starch syrup. JP-A 61-187740 describes that addition of gluten results in a crepe dough that is slightly hard and solid, but also that a dough containing less than 20% by weight of starch sugar is easy to age by wheat flour starch. The method thus has a difficulty in preventing temporal degradation of feel of food without starch sugar.

In addition, from the point of health trend, processed starches attract a lot of attention with their physiology.

For example, an acetylated phosphate-crosslinked starch having a substitution degree of 0.06 and a hydroxypropylated phosphate-crosslinked starch having a substitution degree of 0.10 to 0.14 show resistance to α-amylase digestion and suggest their effects of preventing a rapid increase in blood glucose level after a meal and following induction of hyperglycemia and hypersecretion of insulin (Ebihara, Nihon Eiyou/Syokuryo Gakkaishi (Journal of Japanese Society of Nutrition and Food Science), Vol. 45 (6), p. 551 (1992).

It is also disclosed that a hydroxypropylated starch, acetylated starch and octanylsuccinate starch are effective as an agent of preventing and ameliorating obesity and as an agent for preventing visceral fat accumulation (JP-A 2004-269458 and JP-A 2006-76918). JP-A-2004-269458 and JP-A-2006-76918 describe that a high concentration of a processed starch is effective for exhibiting physiological functions and a blending amount thereof is preferably in the range of 20 to 100% by weight.

### SUMMARY OF THE INVENTION

The present invention provides a grain powder composition containing (A) wheat flour, (B) gelatinized modified starch, and (C) wheat protein, wherein a mass ratio of (A)/(B) is 55/45 to 85/15 and a content of (C) is 0.5 to 4 parts by mass with respect to the total 100 parts by mass of (A) and (B).

Further, the present invention provides baked confectionery containing the above shown grain powder composition and a method of producing baked confectionery including a step of mixing the grain powder composition.

### DETAILED DESCRIPTION OF THE INVENTION

As described in background of the invention, it is demanded to incorporate a more amount of a processed starch from the point of physiology and, if so, achieve feel of food, such as a dissolving feel in the mouth and a moist feel, and prevention of deterioration thereof with time.

The present invention provides a grain powder composition with which baked confectionary is produced to have a dissolving feel in the mouth and a moist feel, maintained with time.

The present inventors have investigated to produce baked confectionary containing a processed starch and having a moist feel and being improved against deterioration of powdery feel in the mouth and dissolving feel in the mouth. The deterioration is remarkable in the presence of processed starch. As described above, it is known that use of gluten only generally results in a hard dough and deterioration with time. The present inventors have found that combined use of a specified processed starch and a specified amount of gluten is effective for improving feeling of food and maintained feeling of food with time.

According to the present invention, baked confectionary can be produced, which has a dissolving feel in the mouth and a moist feel without a powdery feel in the mouth and a suppressed deterioration of the feels with time.

The grain powder composition for baked confectionary of the present invention contains (A) wheat flour, (B) gelatinized modified starch, and (C) wheat protein.

### <(A) Wheat Flour>

Examples of the wheat flour include weak flour, moderate wheat flour, semi-hard wheat flour and hard wheat flour. In general, weak flour is used for baked confectionary.

Weak flour is produced from soft wheat. Examples of the wheat for flour production include western white wheat and white club wheat. In the present invention, a protein content of the weak flour is preferably 6.5 to 9% by mass (hereinafter, simply referred to as %), and more preferably 6.8 to 8%.

### <(B) Gelatinized Modified Starch>

In the present invention, gelatinized modified starch is used as a modified starch.

Gelatinizing (Pregelatinization) refers to a phenomenon in which a starch is heat-treated in the presence of water to cause loss of crystallinity of starch particles, resulting in the starch swelling or dissolving. The gelatinizing is equivalent to gelatinization. A degree of gelatinization can be measured by a standard β-amylase/pullulanase method (Michinori Nakamura and Keiji Kainuma eds., “Seibutsu Kagaku Jikkenhou 19, Denpun/Kanren Toushitsu Jikkenhou (Biochemical Experimental Methods, 19, Experimental Methods on Starch and Related Saccharides)”, Gakkai Syuppan Center (Japan Scientific Societies Press) (1986), pp. 190-192).

In general, a degree of gelatinization of a starch ungelatinized is not more than 10%.

In the present invention, to achieve a moist feel, a processed starch having a high degree of gelatinization is preferably used. More specifically, degree of gelatinization is preferably 20 to 100%, more preferably 30 to 99%, and even more preferably 40 to 98%.

A processed starch preferably used is an esterified starch or an etherified starch.

The esterified starch refers to those produced by bonding a functional group to a starch via an ester bond. Examples of esterification include acetylation, modification with octenyl succinate, and modification with phosphate monoester. The esterified starch can be produced through modification by treating a starch with acetic anhydride, octenyl succinate, phosphate, or the like. Examples of the phosphate include ortho-sodium phosphate and sodium tripolyphosphate. Examples of the esterified starch include acetylated, phosphate-modified starch, succinate-modified starch, acetate-modified, nitrate-modified starch and xanthate-modified starch.

The etherified starch refers to those produced by bonding a functional group to a starch via an ether bond. Examples of the etherified starch include carboxymethylated, hydroxypropylated, hydroxyethylated, and carboxyethlated starches. For the etherified starch, from the point of feel of food, hydroxypropylated starches are preferred.

A degree of modification is represented by a substitution degree, and generally defined by the number of substituents per glucose residue. A starch having larger substitution degree is modified to a larger degree. In this case, the starch has lower gelatinizing temperature, more swells due to hydration, and can give less powdery feel in the mouth.

The effects of the invention can be achieved with any gelatinized modified starch, and also sufficiently achieved with a processed starch having a substitution degree of more than 0.04.

Further, from the viewpoint of physiology, for the esterified starch, a substitution degree is preferably more than 0.04, more preferably 0.05 to 0.1, and even more preferably 0.06 to 0.09. From the viewpoint of physiology, for the etherified starch, a substitution degree is preferably more than 0.1, more preferably 0.1 to 0.5, and even more preferably 0.1 to 0.3.

A substitution degree can be measured by a method described in “Denpun/Kanren Toushitsu Jikkenhou (Experimental Methods on Starch and Related Saccharides)” ((M. Nakamura and K. Kainuma eds., supra, 1986), pp. 290 to 297.

These esterified and etherified starches are preferably further subjected to a cross-linking treatment.

Examples of the cross-linking treatment include phosphate cross-linking and adipate cross-linking. Preferred are acetylated adipate-crosslinked starch, acetylated phosphate-crosslinked starch, hydroxypropylated phosphate-crosslinked starch, phosphate monoester-modified phosphate-crosslinked starch, because these can be produced from starch with a simple process at relatively low cost with high purity.

A degree of cross-linking is represented by a degree of swelling. A starch having higher degree of cross-linking often has lower degree of swelling, harder feel of food, and more powdery feel in the mouth. A starch having a lower degree of cross-linking, or a higher degree of swelling has starch particles which are easily broken, and age more easily. However, in the present invention, combined use with the wheat protein (C) enables prevention of aging, even when a crosslinked starch having a high degree of swelling is used, and can provide baked confectionary having an excellent feel of food for a long time of storage.

Putting these points together, a degree of swelling is preferably not less than 8, more preferably not less than 12, and even more preferably more than 15, and also preferably not more than 29, and more preferably not more than 25.

A degree of swelling is determined and represented as follows. 1.0 g of a sample based on dry weight is dispersed in 100 ml of pure water, heated to 90° C. for 30 minutes, then cooled to 30° C., and subjected to centrifugation (3000 rpm, for 10 minutes) to separate a resultant gelatinized liquid into a gel layer and a supernatant. The gel layer is measured for weight (X1), dried (105° C., steady volume), and again measured for weight (X2). A ratio X1/X2 is a degree of swelling.

Examples of the raw material for the gelatinized modified starch include waxy corn starch, corn starch, wheat starch, rice starch, glutinous rice starch, potato starch, sweet potato starch, and tapioca starch.

In the grain powder composition for baked confectionary, a compounding ratio by mass of the wheat flour (A) to the gelatinized modified starch (B), represented by (A)/(B), is 55/45 to 85/15, and more preferably 60/40 to 80/20. The composition containing them in such a ratio can achieve good feel of food, particularly a sufficient moist feel, and have sufficiently promising physiological properties.

### <(C) Wheat Protein>

The wheat protein (C) used in the present invention is extracted from wheat flour, being different from wheat protein which exists in grain powder. The wheat protein preferably has high content of protein, more preferably of not less than 60%, and even more preferably not less than 70%.

For the wheat protein, commercial products can be used. For example, A-glu series (e.g., A-glu WP, A-glu G, and A-glu K) and Fineglu VP (Glico Foods Co., Ltd.) are preferably used.

A content of the wheat protein with respect to 100 parts by mass (hereinafter, simply referred to as parts) of the total of the wheat flour (A) and the gelatinized modified starch (B) is 0.5 to 4 parts, preferably 0.5 to 3 parts, and more preferably 0.8 to 2 parts. An improvement in a moist feel and a maintained stability thereof with time can be achieved by the content of 0.5 to 4 parts of wheat protein with respect to 100 parts by mass of the total of the wheat flour (A) and the gelatinized modified starch (B).

The composition as described above can also prevent break of starch particles in heating when the gelatinized modified starch (B) has high substitution degree, and hence can prevent aging (hardening with time) and also achieve an improved dissolving feel in the mouth and a decreased powdery feel in the mouth.

The grain powder composition can be produced by compounding wheat flour (A), gelatinized modified starch (B) and wheat protein (C).

The grain powder composition for baked confectionary may further contain optional additives such as a saccharide, oil-and-fat, a swelling agent, table salt, a flavorant, and an emulsifier in addition to the wheat flour (A), the gelatinized modified starch (B), and the wheat protein (C). In the present invention, a saccharide is used to impart a sweet taste, a color, and moisture-retaining properties. Examples of the saccharide include table sugar, glucose, starch syrup, maltose, and sorbitol.

The total amount of these optional additives is preferably not more than 200 parts, and more preferably not more than 150 parts with respect to 100 parts of the total of the wheat flour (A) and the gelatinized modified starch (B).

A content of the saccharide is preferably not more than 90 parts, and more preferably not more than 70 parts with respect to 100 parts of the total of the wheat flour (A) and the gelatinized modified starch (B). A content of the oil-and-fat is preferably not more than 70 parts, and more preferably not more than 60 parts with respect to 100 parts of the total of the wheat flour (A) and the gelatinized modified starch (B).

### <Baked Confectionary>

Baked confectionary comprising the grain powder composition can be produced by mixing the grain powder composition. The baked confectionery can be produced by mixing the grain powder composition as a main ingredient to prepare a dough and baking it.

Examples of the baked confectionary according to the present invention include cookies, biscuits, shortbreads, crackers, hardtacks, pretzels, pies, cut breads, and processed products thereof. From the viewpoints of importance of a dissolving feel in the mouth and no powdery feel in the mouth, preferred are cookies, biscuits, shortbreads and crackers.

A recent trend for biscuits, cookies and shortbreads is a softer feel of food. The baked confectionary according to the present invention preferably have a water content of 5 to 15%, and preferably 6 to 12%. Considering storage stability, the baked confectionary preferably has a water activity of 0.4 to 0.8, and more preferably 0.5 to 0.7.

As raw materials for the baked confectionary of the present invention, in addition to the grain powder composition as a main component, sub materials can be used, including saccharides, oil-and-fats, egg, water, dairy products, common salt, yeast, sodium glutamates and nucleic acids, preservatives, reinforcing agents such as vitamins and calcium, proteins, amino acids, chemical expanding agents, flavors, sweeteners, which are appropriately selected according to need. Dry fruits such as raisin, wheat bran, whole grain, and chocolates can further be appropriately used.

Saccharides used in the present invention can be any saccharide generally used for baked confectionary. Specific examples of the saccharide include monosaccharides such as glucose, fructose, and galactose, polysaccharides such as maltose, sucrose, malt sugar, starch syrup, isomerized sugar, invert sugar, cyclodextrin, branched cyclodextrin, and dextrin, and reduced sugars such as starch hydrolysates. These may be used alone or in combination.

A total content of saccharides derived from the grain powder composition for baked confectionary and from sub ingredients in the baked confectionary is 5 to 90 parts, preferably 10 to 70 parts, and more preferably 15 to 55 parts with respect to 100 parts of the total of components (A) and (B).

The oil-and-fats used in the present invention may be of animal or vegetable. Examples thereof include those having flexibility such as butter, lard, margarine, and shortening, liquid oils and hydrogenated oils (solid fats) prepared therefrom, and interesterified oils. Various oil-and-fats can be used.

A total content of oil-and-fats derived from the grain powder composition for baked confectionary and from sub ingredients in the baked confectionary is 5 to 72 parts, preferably 10 to 60 parts, and more preferably 20 to 55 parts with respect to 100 parts of the total of components (A) and (B).

For the sweetener, sugar alcohols such as sorbitol, maltitol, and xylitol, sucralose, aspartame, and acesulfame-potassium can be used.

In an aspect of the present invention, methods of producing baked confectionary include rotary, cutting-embossing, wire-cutting, route-press, and depositing.

### EXAMPLES

The present invention is described more in details by reference to Examples. The Examples are provided for illustrative purposes only and not intended to limit the present invention.

### <Wheat Flour>

A weak flour (Nisshin Flour Milling Co., Violet, protein content: 7.1%) was used.

### <Modified Starch>

For modified starches used in Examples, degrees of substitution with acetyl group and hydroxypropyl group, of swelling, and of degree of gelatinization are shown in Table 1.

In Examples, degrees of substitution and gelatinization were measured according to methods described in the above-described Document. A degree of swelling was measured by the method described above.

TABLE 1

| | | | Degree of | Degree of | Degree of | |
|---|---|---|---|---|---|---|
| Kind of starch | Trade name | Supplier | substitution | swelling | gelatinization | Abbreviation |
| Gelatinized acetylated adipate- | Ultra-Tex 2 | National Starch Food Innovation | 0.08 | 18 | 58% | αAc-Ad cl 1 |
| crosslinked starch (1) | | | | | | |
| Gelatinized acetylated adipate- | Instant Clear gel | National Starch Food Innovation | 0.08 | 17 | 51% | αAc-Ad cl 2 |
| crosslinked starch(2) | | | | | | |
| Gelatinized hydroxypropylated | Ultra-Tex 4 | National Starch Food Innovation | 0.15 | 14 | 98% | αHP-P cl |
| phosphate-crosslinked starch | | | | | | |
| Gelatinized starch(not modified) | Waxy-alpha D-6 | Nihon Shokuhin Kako Co., Ltd. | — | 4 | 99% | α |

### <Wheat Protein>

A-Glu WP (Glico Foods Co., Ltd., protein content: 78%) was used.

The weak flour and processed starches described above were mixed in amounts shown in Table 2 to prepare grain powder compositions 1 to 8.

In addition, other ingredients were mixed in amounts as shown below to prepare shortbreads of Examples and Comparative Examples.

<Ingredient composition>

| | | |
|---|---|---|
| ingredient a | | |
| margarine | 48 | parts |
| processed edible oil | 3 | parts |
| superfine sugar | 25 | parts |
| oligosaccharide | 5 | parts |
| skim milk powder | 5 | parts |
| concentrated soybean protein | 5 | parts |
| cheese powder | 8 | parts |
| dried albumen | 2 | parts |
| table salt | 1 | part |
| ingredient b | | |
| whole egg | 29 | parts |
| ingredient c | | |
| grain powder composition | 100 | parts |
| ingredient d | | |
| wheat protein | 0 to 3 | parts |

### [Method of Preparing a Shortbread]

1) Ingredient a (margarine, processed edible oil, superfine sugar, oligosaccharide, skim milk powder, concentrated soybean protein, cheese powder, dried albumen, table salt) in amounts as shown above was stirred in a mixer for 30 seconds at a low speed and further for three minutes at a middle speed to prepare a dough.

2) To the dough prepared in (1) was added egg mixture (ingredient b) as three aliquots while stirring for 30 seconds at a low speed. A first aliquot of egg mixture was added and then stirred for 30 seconds at a low speed. A second aliquot of egg mixture dissolving table salt was added and stirred for 30 seconds at a low speed.

Then, oil adhered on the wall of the mixer was scraped. The last aliquot of egg mixture was added and stirred for 30 seconds at a low speed, and further at a middle speed until a mixture became a uniform cream (stirring time at a middle speed: 1 minute)

3) To the cream prepared in (2) was added ingredients c and d, which were previously mixed, and stirred for 45 seconds at a low speed.

4) 20 g of the dough prepared in (3) was packed in a rectangular baking pan having dimensions of 72 mm long by 22 mm wide by 14 mm high. The baking pan was placed on a baking sheet lined with parchment paper. Six holes were created on the surface of the dough in the pan with a toothpick. Baking pans thus prepared were arranged such that three lines each consisting of four pans, total twelve pans, per baking sheet.

5) The baking sheet was layered on three baking sheets and covered with aluminum foil.

6) Baking was conducted at 160° C. for 20 minutes with aluminum foil covering and then for 20 minutes without aluminum foil covering in an oven.

7) The baked product was cooled for 20 minutes at a room temperature on a net, placed in a polyethylene zipper bag, and stored in a temperature-controlled room at 20° C. for 1 or 7 days to give a shortbread sample.

Examples and Comparative Examples were evaluated using shortbread samples stored for 1 and 7 days from the production. Samples were subjected to sensory evaluations for shortcrust property, powdery feel in the mouth, dissolving feel in the mouth, and moist feel.

### [Sensory Evaluation]

5: very good compared with Control Example

4: good compared with Control Example

3: equal to Control Example

2: poor compared with Control Example

1: very poor compared with Control Example

For samples stored for 7 days, evaluations of Control Example after 1 day were set to 3 and used as standards for relatively evaluating samples.

### Examples 1 to 5 and Comparative Examples 1 to 3

Shortbread samples were prepared using gelatinized acetylated adipate-crosslinked starch (1), weak flour, and wheat protein in various ratios of the weak flour to the starch (1) and various contents of the wheat protein, and subjected to sensory evaluations. Compositions of ingredients for baked confectionary and results of sensory evaluations of resultant samples are shown in Table 3.

### Comparative Example 4

A shortbread sample was similarly prepared as in Example 2, except that an unprocessed gelatinized starch was used instead of the gelatinized modified crosslinked starch, and subjected to sensory evaluations. A composition of ingredients for baked confectionary and results of sensory evaluations of a resultant sample are shown in Table 3.

### Examples 6 to 7

Shortbread samples were similarly prepared as in Example 2, except that gelatinized acetylated adipate-crosslinked starch (2) and gelatinized hydroxypropylated phosphate-crosslinked starch were used as gelatinized modified crosslinked starch, and subjected to sensory evaluations.

Compositions of ingredients for baked confectionary and results of sensory evaluations of resultant samples are shown in Table 4.

### Comparative Example 5

A shortbread sample was similarly prepared as in Example 7 using gelatinized acetylated adipate-crosslinked starch (2) as gelatinized modified crosslinked starch, except that wheat protein was not used, and subjected to sensory evaluations.

A composition of ingredients for baked confectionary and results of sensory evaluations of a resultant sample are shown in Table 4.

TABLE 2

| | Grain | Grain | Grain | Grain | Grain | Grain | Grain | Grain |
|---|---|---|---|---|---|---|---|---|
| Grain powder composition | powder 1 | powder 2 | powder 3 | powder 4 | powder 5 | powder 6 | powder 7 | powder 8 |
| Weak flour | 90 | 85 | 70 | 60 | 50 | 70 | 70 | 70 |
| Gelatinazed acetylated adipate-crosslinked | 10 | 15 | 30 | 40 | 50 | — | — | — |
| starch(1)(αAc-Ad cl 1) | | | | | | | | |
| Gelatinazed acetylated adipate-crosslinked | — | — | — | — | — | 30 | — | — |
| starch(2)(αAc-Ad cl 2) | | | | | | | | |
| Gelatinazed hydroxypropylated phosphate- | — | — | — | — | — | — | 30 | — |
| crosslinked starch (αHP-P cl) | | | | | | | | |
| Gelatinazed starch(not modified) | | | | | | — | — | 30 |
| Total | 100 | 100 | 100 | 100 | 100 | 100 | 100 | 100 |

TABLE 3

| | | | | | | Comparative | Comparative | Comparative | Comparative | Control |
|---|---|---|---|---|---|---|---|---|---|---|
| Starting material | Example 1 | Example 2 | Example 3 | Example 4 | Example 5 | example 1 | example 2 | example 3 | example 4 | example |
| Material a | 102 | 102 | 102 | 102 | 102 | 102 | 102 | 102 | 102 | 102 |
| Material b: whole egg | 29 | 29 | 29 | 29 | 29 | 29 | 29 | 29 | 29 | 29 |
| Material c: Grain | Grain | Grain | Grain | Grain | Grain | Grain | Grain | Grain | Grain | — |
| powder composition | powder 3 | powder 3 | powder 3 | powder 4 | powder 2 | powder 3 | powder 5 | powder 1 | powder 8 | |
| Weak flour | 70 | 70 | 70 | 60 | 85 | 70 | 50 | 90 | 70 | 100 |
| Gelatinazed modified | 30 | 30 | 30 | 40 | 15 | 30 | 50 | 10 | — | — |
| crosslinked starch | | | | | | | | | | |
| Gelatinazed starch | — | — | — | — | — | — | — | — | 30 | — |
| Total of grain powder | 100 | 100 | 100 | 100 | 100 | 100 | 100 | 100 | 100 | 100 |
| Kind of modified | Ac-Ad | Ac-Ad | Ac-Ad | Ac-Ad | Ac-Ad | Ac-Ad | Ac-Ad | Ac-Ad | — | — |
| starch | cl 1 | cl 1 | cl 1 | cl 1 | cl 1 | cl 1 | cl 1 | cl 1 | | |
| Material d: Flour | 0.5 | 1 | 3 | 1 | 1 | — | 1 | 1 | 1 | — |
| protein | | | | | | | | | | |
| Sensory evaluation | | | | | | | | | | |
| of texture | | | | | | | | | | |
| (after one day) | | | | | | | | | | |
| Shortcrust property | 4 | 4 | 3 | 4 | 4 | 3 | 3 | 3 | 3 | 3 |
| No powdery feel in | 5 | 5 | 5 | 5 | 5 | 4 | 4 | 5 | 3 | 3 |
| the mputh | | | | | | | | | | |
| Dissolving feel in | 5 | 5 | 4 | 4 | 4 | 4 | 3 | 2 | 2 | 3 |
| the mouth | | | | | | | | | | |
| Moist feel | 5 | 5 | 4 | 5 | 4 | 4 | 3 | 4 | 3 | 3 |
| (after seven day) | | | | | | | | | | |
| Shortcrust property | 3 | 3 | 3 | 3 | 3 | 1 | 1 | 2 | 2 | 2 |
| No powdery feel in | 5 | 5 | 4 | 5 | 4 | 2 | 3 | 3 | 2 | 2 |
| the mputh | | | | | | | | | | |
| Dissolving feel in | 4 | 5 | 4 | 4 | 4 | 2 | 1 | 2 | 1 | 2 |
| the mouth | | | | | | | | | | |
| Moist feel | 4 | 4 | 3 | 4 | 3 | 2 | 3 | 2 | 2 | 2 |

TABLE 4

| | | | Comparative | Control |
|---|---|---|---|---|
| Starting material | Example 6 | Example 7 | example 5 | example |
| Material a | 102 | 102 | 102 | 102 |
| Material b: whole egg | 29 | 29 | 29 | 29 |
| Material c: grain | Grain | Grain | Grain | — |
| powder composition | powder 6 | powder 7 | powder 7 | |
| Weak flour | 70 | 70 | 70 | 100 |
| Glatinized processed | 30 | 30 | 30 | — |
| crosslinked starch | | | | |
| Glatinized starch | — | — | — | — |
| Total of grain powder | 100 | 100 | 100 | 100 |
| Kind of modified | Ac-Ad | HP-P | HP-P | — |
| starch | cl 2 | cl | cl | |
| Material d: wheat | 1 | 1 | — | — |
| protein | | | | |
| Sensory evaluation | | | | |
| of texture | | | | |
| (after one day) | | | | |
| Shortcrust property | 4 | 4 | 3 | 3 |
| No powdery feel in | 5 | 5 | 4 | 3 |
| the mputh | | | | |
| Dissolving feel in | 4 | 4 | 3 | 3 |
| the mouth | | | | |
| Moist feel | 4 | 4 | 4 | 3 |
| (after seven day) | | | | |
| Shortcrust property | 3 | 3 | 1 | 2 |
| No powdery feel in | 4 | 5 | 2 | 2 |
| the mputh | | | | |
| Dissolving feel in | 3 | 4 | 2 | 2 |
| the mouth | | | | |
| Moist feel | 3 | 4 | 2 | 2 |

It was clearly shown that baked confectionary prepared with a specific gelatinized modified starch and wheat protein in the range according to the present invention had a non-conventional moist feel and a better dissolving feel in the mouth than ever and maintenance of the feel of food with time even if the baked confectionary contained the gelatinized modified starch in an amount sufficient to achieve its physiological functions.

1. A grain powder composition, comprising (A) wheat flour, (B) an gelatinized modified starch, and (C) wheat protein,
wherein a mass ratio of (A)/(B) is 55/45 to 85/15, and
a content of (C) is 0.5 to 4 parts by mass with respect to the total 100 parts by mass of (A) and (B).

2. The grain powder composition according to claim 1, wherein a degree of gelatinization of the gelatinized modified starch is 20 to 100%.

3. The grain powder composition according to claim 1 or 2, wherein the gelatinized modified starch is gelatinized esterified starch or gelatinized etherified starch.

4. The grain powder composition according to claim 1 or 2, wherein the gelatinized modified starch is gelatinized acetylated starch or gelatinized hydroxypropylated starch.

5. The grain powder composition according to claim 1 or 2, wherein the gelatinized modified starch is a crosslinked starch.

6. A baked confectionery, comprising the grain powder composition according to claim 1.

7. The baked confectionery according to claim 6, which is selected from the group consisting of cookies, biscuits, shortbreads and crackers.

8. The baked confectionery according to claim 6 or 7, having a water content of 5 to 15% by mass.

9. The method of producing baked confectionery, comprising a step of mixing the grain powder composition according claim 1 or 2.
